(19) United States
(12) Patent Application Publication
(10) Pub. No.: US 2024/0385477 A1
(43) Pub. Date: Nov. 21, 2024

(54) DISPLAY DEVICE AND OPTICAL FILM

(71) Applicant: Sharp Display Technology Corporation, Kameyama City (JP)

(72) Inventors: Hisashi WATANABE, Kameyama City (JP); Hirotoshi YASUNAGA, Kameyama City (JP)

(21) Appl. No.: 18/633,417

(22) Filed: Apr. 11, 2024

(30) Foreign Application Priority Data
May 16, 2023 (JP) 2023-080818

(51) Int. Cl. G02F 1/1335; G02B 5/30

(52) U.S. Cl. CPC G02F 1/133531; G02B 5/3041; G02F 1/133509

(57) ABSTRACT

Provided are a display device and an optical film that are capable of providing vivid reflective display without a decrease in luminance. The display device includes: an optical film; and a display panel placed closer to a back surface side than the optical film is. The optical film includes a colored semi-transparent component and a first linear polarizer or louver film being placed closer to the back surface side than the colored semi-transparent component is and being integrated with the colored semi-transparent component, the louver film including a light absorptive part and a light transmissive part arranged in a pattern. The semi-transparent component is configured to transmit part of light incident from the back surface side and reflect part of light incident from a viewer side opposite to the back surface side.

### CROSS-REFERENCE TO RELATED APPLICATIONS

The present application claims priority under 35 U.S.C. § 119 to Japanese Patent Application No. 2023-080818 filed on May 16, 2023, the contents of which are incorporated herein by reference in their entirety.

### BACKGROUND OF THE INVENTION

### Field of the Invention

The present disclosure relates to display devices and optical films.

### Description of Related Art

Conventional display devices typically display desired images on their display screen when lighted while making their display screen appear black when unlighted. Considerations have been made to improve the designability of such display devices by making the display screen, when unlighted, harmonizable with the surrounding components and the enclosure, for example, and thereby making the display screen less noticeable.

The display screen is made less noticeable when unlighted by, for example, placing on a front surface side of the display panel a semi-transparent component transmitting part of light, such as a screen or a decorative film (e.g., JP 2001-331132 A, JP 6696014 B).

JP 2001-331132 A discloses a display device including a display fitted in an attached portion and emitting a display light to an outside during lighting; a screen covering a front face of the display having a large number of minute holes capable of transmitting the display light, wherein a surface of the screen has the same color and pattern as those of the attached portion on a periphery of the display.

JP 6696014 B discloses a display device with a decorative sheet including: a display device having a display surface; and a decorative sheet that is provided to face the display surface. The decorative sheet includes a picture pattern portion and a plurality of transmitting portions that are portions in which the picture pattern portion is not formed, wherein an aperture ratio is 5% or more and 50% or less, and each of the transmitting portions is formed such that a distance between the transmitting portions adjacent to each other is 40 μm or more and 140 μm or less. The display device is a dot matrix liquid crystal display, and a pitch of each of the transmitting portions is larger than a pitch of a pixel on the display surface.

### BRIEF SUMMARY OF THE INVENTION

When a display device is unlighted, a semi-transparent component placed on the viewer side of the display panel reflects part of ambient light so that the viewer sees the color and pattern of the semi-transparent component. The studies made by the present inventors found that when an air layer is present between the semi-transparent component and the display panel, part of ambient light transmitted through the semi-transparent component undergoes interface reflection in the interfaces with the air. Since interface reflection causes incident light to be reflected with almost no change in color, the color of the interface-reflected light includes the complementary color of the color of the semi-transparent component and the complementary color of the pattern of the semi-transparent component. Thus, when light reflected by the semi-transparent component and the interface-reflected light are mixed, the semi-transparent component sometimes appears not in a vivid color but whitish.

In a conventional technique disclosed in JP 2001-331132 A, for example, the smoke plate 23 is placed in the back surface side of the screen 20 (see FIG. 2) to increase the contrast ratio. A smoke plate, however, undesirably absorbs also light to be transmitted therethrough, which is light emitted from the display panel side toward the viewer side, to decrease the luminance during transmissive display in some cases. To increase the luminance during transmissive display, the luminance of components such as the backlight needs to be increased, which however involves issues such as an increase in power consumption and heat buildup.

The studies made by the present inventors also revealed that the whitish appearance during reflective display does not matter when a semi-transparent component having a silverish reflective surface is used which almost uniformly reflects light with any wavelength falling in the visible spectrum, whereas the whitish appearance matters when a colored semi-transparent component is used which reflects light with a specific wavelength. A display device or an optical film including a colored semi-transparent component thus leaves room for improvement to provide both vivid reflective display and high-luminance transmissive display.

In response to the above issues, an object of the present invention is to provide a display device and an optical film which are capable of providing vivid reflective display without a decrease in luminance.
(1) One embodiment of the present invention is directed to a display device including: an optical film; and a display panel placed closer to a back surface side than the optical film is, the optical film including a colored semi-transparent component and a first linear polarizer or louver film being placed closer to the back surface side than the colored semi-transparent component is and being integrated with the colored semi-transparent component, the louver film including a light absorptive part and a light transmissive part arranged in a pattern, the semi-transparent component being configured to transmit part of light incident from the back surface side and reflect part of light incident from a viewer side opposite to the back surface side.
(2) In an embodiment of the present invention, the display device includes the structure (1), the display panel includes a second linear polarizer placed closer to the viewer side, and a transmission axis of the first linear polarizer is parallel to a transmission axis of the second linear polarizer.
(3) In an embodiment of the present invention, the display device includes the structure (1) or (2), and the first linear polarizer is an absorptive linear polarizer.
(4) In an embodiment of the present invention, the display device includes the structure (1), and the light absorptive part and the light transmissive part of the louver film are alternately arranged in a plan view.
(5) In an embodiment of the present invention, the display device includes any one of the structures (1) to (4), and a transmittance of the semi-transparent component for light incident from the back surface side is 50% or higher.
(6) In an embodiment of the present invention, the display device includes any one of the structures (1) to (5), and the semi-transparent component includes a pigment that reflects light.
(7) In an embodiment of the present invention, the display device includes any one of the structures (1) to (6), and the optical film further includes a first λ/4 waveplate placed closer to the back surface side than the first linear polarizer is.
(8) In an embodiment of the present invention, the display device includes the structure (7), and a transmission axis of the first linear polarizer and a slow axis of the first λ/4 waveplate form an angle of substantially 45°.
(9) In an embodiment of the present invention, the display device includes the structure (7) or (8), the display panel includes a second λ/4 waveplate and a second linear polarizer sequentially from the viewer side, and a transmission axis of the second linear polarizer and a slow axis of the second λ/4 waveplate form an angle of substantially 45°, and a slow axis of the first λ/4 waveplate and the slow axis of the second λ/4 waveplate are orthogonal to each other.
(10) In an embodiment of the present invention, the display device includes any one of the structures (1) to (9), the first linear polarizer is a coating-type polarizing layer including dichroic molecules, and the coating-type polarizing layer including dichroic molecules is formed on the semi-transparent component.
(11) In an embodiment of the present invention, the display device includes any one of the structures (1) to (9), and the first linear polarizer is a linear polarizer that includes a polarizing film including dichroic molecules and a pair of protective films between which the polarizing film including dichroic molecules is held.
(12) In an embodiment of the present invention, the display device includes the structure (11), the optical film further includes a transparent film on a surface opposite to the surface on which the first linear polarizer is placed, and a difference in coefficient of linear expansion between the transparent film and one of the protective films is 30×10⁻⁶/K or less.
(13) In an embodiment of the present invention, the display device includes any one of the structures (1) to (9), and the optical film includes the semi-transparent component, the louver film, and a linear polarizer in the stated order.
(14) In an embodiment of the present invention, the display device includes any one of the structures (1) to (13), and the optical film further includes an antireflective layer placed closer to the back surface side than the first linear polarizer or the louver film is.
(15) In an embodiment of the present invention, the display device includes any one of the structures (1) to (14), the display panel in a plan view includes a display region and a frame region surrounding the display region, and the display panel in a plan view includes a light blocking component in a region overlapping the frame region.
(16) Another embodiment of the present invention is directed to an optical film including: a colored semi-transparent component and a first linear polarizer or louver film being placed closer to a back surface side than the colored semi-transparent component is and being integrated with the colored semi-transparent component, the louver film including a light absorptive part and a light transmissive part arranged in a pattern, the semi-transparent component being configured to transmit part of light incident from the back surface side and reflect part of light incident from a viewer side opposite to the back surface side.
(17) In an embodiment of the present invention, the optical film includes the structure (16), and the first linear polarizer is an absorptive linear polarizer.
(18) In an embodiment of the present invention, the optical film includes the structure (16), and the light absorptive part and the light transmissive part of the louver film are alternately arranged in a plan view.
(19) In an embodiment of the present invention, the optical film includes any one of the structures (16) to (18), and a transmittance of the semi-transparent component for light incident from the back surface side is 50% or higher.
(20) In an embodiment of the present invention, the optical film includes any one of the structures (16) to (19), the semi-transparent component includes a pigment that reflects light.
(21) In an embodiment of the present invention, the optical film includes any one of the structures (16) to (20), and the optical film further includes a first λ/4 waveplate placed closer to the back surface side than the first linear polarizer is.
(22) In an embodiment of the present invention, the optical film includes the structure (21), and a transmission axis of the first linear polarizer and a slow axis of the first λ/4 waveplate form an angle of substantially 45°.
(23) In an embodiment of the present invention, the optical film includes any one of the structures (16) to (22), the first linear polarizer is a coating-type polarizing layer including dichroic molecules, and the coating-type polarizing layer including dichroic molecules is formed on the semi-transparent component.
(24) In an embodiment of the present invention, the optical film includes any one of the structures (16) to (22), and the first linear polarizer is a linear polarizer that includes a polarizing film including dichroic molecules and a pair of protective films between which the polarizing film including dichroic molecules is held.
(25) In an embodiment of the present invention, the optical film includes the structure (24), the optical film further includes a transparent film on a surface opposite to the surface on which the first linear polarizer is placed, and a difference in coefficient of linear expansion between the transparent film and one of the protective films is 30×10⁻⁶/K or less.
(26) In an embodiment of the present invention, the optical film includes any one of the structures (16) to (22), and the optical film includes the semi-transparent component, the louver film, and a linear polarizer in the stated order.
(27) In an embodiment of the present invention, the optical film includes any one of the structures (16) to (26), and the optical film further includes an antireflective layer placed closer to the back surface side than the first linear polarizer is.

The present invention can provide a display device and an optical film that are capable of providing vivid reflective display without a decrease in luminance.

### BRIEF DESCRIPTION OF THE DRAWINGS

FIG. 1 is a schematic plan view of an example of a display device according to Embodiment 1.

FIG. 2 is a schematic cross-sectional view taken along line X1-X2 in FIG. 1.

FIG. 3A is an explanatory diagram showing transmissive display provided by the display device according to Embodiment 1.

FIG. 3B is an explanatory diagram showing reflective display provided by the display device according to Embodiment 1.

FIG. 4A is an explanatory diagram showing transmissive display provided by a display device according to Comparative Embodiment 1.

FIG. 4B is an explanatory diagram showing reflective display provided by the display device according to Comparative Embodiment 1.

FIG. 5A is an explanatory diagram showing transmissive display provided by a display device according to Comparative Embodiment 2.

FIG. 5B is an explanatory diagram showing reflective display provided by the display device according to Comparative Embodiment 2.

FIG. 6 is a schematic cross-sectional view of an example of a display device according to Embodiment 2.

FIG. 7A is an explanatory diagram showing transmissive display provided by the display device according to Embodiment 2.

FIG. 7B is an explanatory diagram showing reflective display provided by the display device according to Embodiment 2.

FIG. 8 is a schematic cross-sectional view showing an example of a display device according to Embodiment 3.

FIG. 9A is an explanatory diagram showing transmissive display provided by the display device according to Embodiment 3.

FIG. 9B is an explanatory diagram showing reflective display provided by the display device according to Embodiment 3.

FIG. 10 is a schematic cross-sectional view showing an example of a display device according to Embodiment 4.

FIG. 11 is a schematic cross-sectional view showing an example of a display device according to Embodiment 5.

FIG. 12 is a schematic cross-sectional view showing an example of a display device according to Embodiment 6.

FIG. 13 is a schematic cross-sectional view showing an example of a display device according to Embodiment 7.

FIG. 14 is a perspective view showing an example of a louver film.

FIG. 15 is a schematic cross-sectional view showing an example of a display device according to Embodiment 8.

FIG. 16 is a schematic cross-sectional view showing an example of an optical film according to Embodiment 9.

FIG. 17 is a schematic cross-sectional view showing another example of the optical film according to Embodiment 9.

FIG. 18 is a schematic cross-sectional view showing an example of an optical film according to Embodiment 10.

FIG. 19 is a schematic cross-sectional view showing an example of an optical film according to Embodiment 11.

FIG. 20 is a schematic cross-sectional view showing an example of an optical film according to Embodiment 12.

FIG. 21 is a schematic cross-sectional view showing an example of an optical film according to Embodiment 13.

FIG. 22 is a schematic cross-sectional view showing an example of an optical film according to Embodiment 14.

### DETAILED DESCRIPTION OF THE INVENTION

Hereinafter, the present invention is described in more detail based on embodiments with reference to the drawings. The present invention is not limited to the following embodiments. In the following description, components having the same or similar functions in different drawings are commonly provided with the same reference sign so as to appropriately avoid repetition of description. The structures in the present invention may be combined as appropriate without departing from the gist of the present invention.

Herein, the expression that two directions are orthogonal to each other means that the angle formed between the two directions falls preferably within the range of 90°±3°, more preferably within the range of 90°±1°, still more preferably within the range of 90° 0.5°. The expression that two directions are parallel to each other means that the angle formed between the two directions falls preferably within the range of 0°±3°, more preferably within the range of 0°±1°, still more preferably within the range of 0°±0.5°.

Herein, the “viewer side” means the surface to be observed by the viewer and is also referred to as the “front surface side”. The “back surface side” means the surface opposite to the viewer side.

### <<Display Device>>

One embodiment of the present invention is directed to a display device including: an optical film; and a display panel placed closer to a back surface side than the optical film is, the optical film including a colored semi-transparent component and a first linear polarizer or louver film being placed closer to the back surface side than the colored semi-transparent component is and being integrated with the colored semi-transparent component, the louver film including a light absorptive part and a light transmissive part arranged in a pattern, the semi-transparent component being configured to transmit part of light incident from the back surface side and reflect part of light incident from a viewer side opposite to the back surface side.

### Embodiment 1

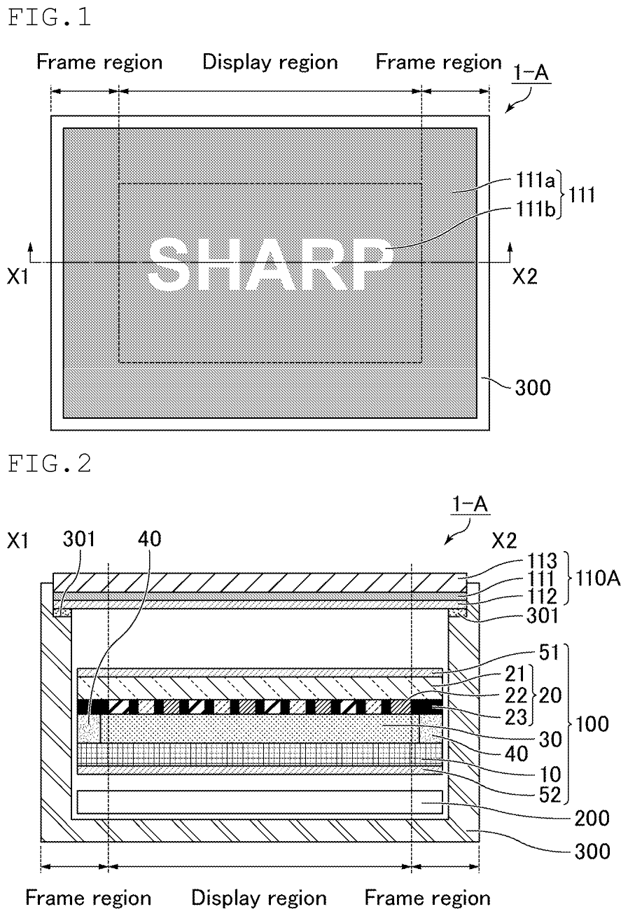

FIG. 1 is a schematic plan view of an example of a display device according to Embodiment 1. FIG. 2 is a schematic cross-sectional view taken along line X1-X2 in FIG. 1. As shown in FIG. 2, a display device 1-A according to Embodiment 1 includes an optical film 110A and a display panel placed closer to the back surface side than the optical film 110A is. The optical film 110A includes a colored semi-transparent component 111 and a first linear polarizer 112 being placed closer to the back surface side than the colored semi-transparent component 111 is and being integrated with the colored semi-transparent component 111.

A smoke layer is placed closer to the back surface side than an optical film is in a conventional device in order to reduce or prevent interface reflection. A smoke layer is, for example, a layer with a low transmittance formed on a surface of a transparent substrate by a technique such as solid printing. An example thereof is a smoke layer with a transmittance of 50% or lower. A typical smoke layer absorbs part of incident light and has a constant absorptivity independent of the polarization state of the incident light and the angle of incidence of the incident light. The present embodiment can provide vivid reflective display by employing, instead of the smoke layer, the first linear polarizer placed closer to the back surface side than the colored semi-transparent component is. In the display device according to the present embodiment, preferably, the optical film 110A includes no smoke layer in its region overlapping the display region of a display panel 100.

In the display device according to the present embodiment, the display panel 100 preferably includes a second linear polarizer 51 placed closer to the viewer side, and the transmission axis of the first linear polarizer 112 and the transmission axis of the second linear polarizer 51 are preferably parallel to each other. With this configuration, the display device can more favorably provide bright transmissive display without a decrease in luminance.

The present embodiment can effectively provide vivid reflective display when, as shown in FIG. 2, applied to a display device in which the optical film and the display panel are apart from each other in the thickness direction, i.e., a display device including an air layer between the optical film and the display panel. In a display device in which a component such as a transparent adhesive is filling the gap between the optical film and the display panel without any air layer, for example, the issue of whitish appearance during reflective display itself is less likely to arise since interface reflection is not likely to occur between the optical film and the display panel.

### <Optical Film>

As shown in FIG. 2, the optical film 110A includes the colored semi-transparent component 111 integrated with the first linear polarizer 112. The integration means simply including no air layer between the semi-transparent component 111 and the first linear polarizer 112; the semi-transparent component 111 and the first linear polarizer 112 may be attached to each other with an adhesive layer, for example, or another component such as a transparent substrate may be present between the semi-transparent component 111 and the first linear polarizer 112.

### (Semi-Transparent Component)

The semi-transparent component is a component that transmits part of light incident from the back surface side and reflects part of light incident from the front surface side (viewer side) opposite to the back surface side. Also, the semi-transparent component is a colored semi-transparent component. The term “colored” means being chromatic colored and excludes achromatic colors such as white and black as well as silver. The “chromatic color” herein refers to a color with different transmittance values for lights in the visible range (400 to 700 nm), such as a color with transmittance values that differ by 30% or more in the range of 400 to 700 nm.

As described above, when being a colored semi-transparent component which is not of an achromatic color or silver, the semi-transparent component is susceptible to influence of interface reflection between the optical film and the display panel. Thus, when the configuration of the present embodiment is applied to a display device including a colored semi-transparent component, whitish appearance during reflective display can be effectively reduced or prevented, so that vivid reflective display can be achieved. The whitish appearance means appearing more in an achromatic color.

The transmittance of the semi-transparent component for light incident from the back surface side may be 50% or higher. When the transmittance of the semi-transparent component is lower than 50%, the luminance of the display device may decrease to make the display image difficult to see in a bright environment. The transmittance of the semi-transparent component is more preferably 70% or higher. The upper limit of the transmittance of the semi-transparent component is, for example, 90%. The transmittance of the semi-transparent component will suffice as long as it is 50% or higher in the region overlapping the display region of the display panel 100.

Herein, the transmittance refers to the total light transmittance and is measured by a method in conformity with JIS K 7361-1. The total light transmittance can be measured, for example, with a device such as a haze meter NDH2000 available form Nippon Denshoku Industries Co., Ltd.

The reflectance of the semi-transparent component for light incident from the viewer side falls within the range of about 3% to about 50%. A reflectance of lower than 3% is ineffective because it causes the color and the pattern to be almost unperceivable. A reflectance of 50% or higher means that the transmittance is lower than 50%, which is not preferred since the displayed image is difficult to see in a bright environment in some cases. The transmittance means the visible light transmittance, and the reflectance means the visible light reflectance.

The semi-transparent component in a plan view may be placed on the entire optical film or may be placed on part of the optical film such that a specific pattern or the like can be expressed. Non-limiting examples of the specific pattern include geometric patterns with designability, wood grain patterns, specific character strings, and company logos. During reflective display, the specific pattern is perceived by the viewer. At least part of the semi-transparent component is chromatic colored, and the semi-transparent component may entirely be colored or may partly include a region of an achromatic color.

Examples of the semi-transparent component include metal thin films, dielectric multilayer films, films containing a pigment that reflects light, and printed layers printed with a pigment that reflects light.

Examples of the metal thin films include those formed using a metal such as aluminum, silver, titanium, or tungsten by metal deposition or sputtering, for example. Most common metal thin films are of an achromatic color, and can be colored by being laminated with a color pigment layer. Examples of such a metal thin film on which a color pigment layer is adsorbed include color anodized aluminum sheets. The thickness of the metal thin film is, for example, from 30 nm to 100 nm. Color anodizing includes, for example, electrolytically treating the surface of aluminum to form an oxide coating and coloring the oxide coating through impregnation with a colorant.

Specifically, a method may be used including forming an aluminum thin film, for example, to a thickness of 100 nm in the “SHARP” letter portion shown in FIG. 1 to produce a semi-transparent mirror including minute pores at an aperture ratio of 50%, while not forming the semi-transparent mirror in the portion surrounding the letter portion. Here, the semi-transparent mirror corresponds to the semi-transparent component. Use of the color anodized aluminum described above as the aluminum enables a colored semi-transparent component.

The films containing a pigment that reflects light (hereinafter, also referred to as a reflective pigment) may be, for example, films obtained by kneading a reflective pigment into a binder resin. The printed layers printed with a reflective pigment may be obtained by, for example, printing on the surface of the transparent base 113 by a printing method such as gravure printing, screen printing, or inkjet printing. When the letters “SHARP” shown in FIG. 1 are to be perceived by the viewer during reflective display, the letter portion and the surrounding portion may be printed with reflective pigments of different colors. Also, one of the letter portion and the surrounding portion may be printed with a reflective pigment while the other may be printed with an ordinary pigment that is not a reflective pigment or may be a resin layer not undergoing printing and not containing a pigment.

The reflective pigment is a pigment that reflects ambient light with specific wavelengths to the viewer side and that causes the viewer to perceive the specific colors corresponding to the wavelengths of light to be reflected. The specific wavelengths are those of light in the visible spectrum (380 nm to 780 nm). The semi-transparent component may contain reflective pigments of multiple colors to cause the viewer to perceive the desired color through additive color mixing of lights reflected by the reflective pigments of multiple colors. When printing is performed with a reflective pigment(s), the resulting printed layer can transmit at least part of light incident from the display panel without the micropores formed in its printing base as in JP 2001-331132 A and JP 6696014 B since there are gaps between the particles of the pigment.

Examples of the reflective pigment include metallic pigments. The metallic pigments may reflect light having specific wavelengths and absorb light having wavelengths other than the specific wavelengths. Examples of the metallic pigments include metallic strips coated with a pigment, and the pigment may be coated with a polymer such as an acrylic resin. Examples of the metallic pigments include “FRIEND COLOR®” available from Toyo Aluminium K.K. Pearl pigments using optical interference can also be used. Representative examples thereof include “Effect pigment” available from Merck KGaA.

The metallic strips are preferably those that reflect visible light, and examples include aluminum, nickel, titanium, stainless steel, and alloys of any of these metals.

The pigment used to coat the metallic strips may be an organic pigment or an inorganic pigment, but is preferably an organic pigment. Examples of the organic pigment include phthalocyanine, halogenated phthalocyanine, quinacridone, diketopyrrolopyrrole, isoindolinone, azomethine metal complexes, indanthrone, perylene, perynone, anthraquinone, dioxazine, benzoimidazolone, condensed azo, triphenylmethane, quinophthalone, and anthrapyrimidine. Examples of the inorganic pigment include titanium oxide, iron oxide, carbon black, and bismuth vanadate.

Other modes of the semi-transparent component include those obtained by, as described in JP 2001-331132 A and JP 6696014 B, forming a specific pattern on a screen with multiple micropores or a decorative film with transmissive parts.

### (First Linear Polarizer)

The first linear polarizer 112 is a linear polarizer that converts incident light to linearly polarized light and is a component that changes the polarization state and/or direction of incident light. The first linear polarizer 112, which can more effectively reduce or prevent interface reflection, is preferably an absorptive linear polarizer that absorbs light polarized in a specific direction and transmits light vibrating in a direction orthogonal to the specific direction.

The first linear polarizer may be a linear polarizer that includes a polarizing film including dichroic molecules and a pair of protective films between which the polarizing film including dichroic molecules is held. Examples of the first linear polarizer include “TEG1465DU” available from Nitto Denko Corporation.

Examples of the polarizing film including dichroic molecules include polyvinyl alcohol (PVA)-based films on which dyeing treatment with iodine and stretching treatment (e.g., uniaxial stretching) have been performed.

The protective films can be those usually used in the field of linear polarizers. Examples thereof include cellulose-based resin films such as triacetyl cellulose (TAC)-based resin films, polyester-based resin films, polyvinyl alcohol-based resin films, polycarbonate-based resin films, polyamide-based resin films, polyimide-based resin films, polyethersulfone-based resin films, polysulfone-based resin films, polystyrene-based resin films, polynorbornene-based resin films, polyolefin-based resin films, (meth)acrylic resin films, and acetate-based resin films. The protective films are preferably transparent films with, for example, a transmittance of 90% or higher.

The first linear polarizer is a coating-type polarizing layer including dichroic molecules. The coating-type polarizing layer including dichroic molecules may be formed on the semi-transparent component. Examples of the coating-type polarizing layer including dichroic molecules include those obtained by coating with a composition including a lyotropic liquid crystalline compound and dichroic dye molecules. Examples of the dichroic dye molecules include dichroic dye molecules having an azo group. The coating-type polarizing layer may be one disclosed in any of JP 2010-250025 A, JP 4622434 B, JP 2568882 B, and JP 3492693 B.

When the first linear polarizer is a polarizer including the polarizing film held between the protective films, the optical film 110A may warp depending on the pressure from attaching the first linear polarizer to the transparent base 113 and the difference in coefficient of linear expansion between the transparent base 113 and the protective films. Use of a coating-type polarizing layer as the first linear polarizer can reduce or prevent warpage of the optical film 110A.

The coating-type polarizing layer including the dichroic molecules may be directly applied to the surface of the semi-transparent component. In this case, the coating-type polarizing layer including dichroic molecules and the semi-transparent component are in contact with each other. Also, an alignment film may be formed on the surface of the semi-transparent component and a coating-type polarizing layer may be formed on the surface of the alignment film. The alignment film can be one usually used in the field of liquid crystal panels.

### (Other Components)

As shown in FIG. 2, the optical film 110A may include a transparent base 113 placed closer to the viewer side than the semi-transparent component 111 is. Although not shown, the optical film 110A may include a transparent base 113 placed closer to the back surface side than the semi-transparent component 111 is.

The transparent base 113 is suitably a component that transmits light, and may be used as a base of the semi-transparent component 111. The transparent base 113 preferably has a high transmittance in order to maintain the luminance of the display device high. For example, the transmittance is preferably 90% or higher. To reduce or prevent blurriness of the displayed image, the transparent base 113 preferably has a haze of 10% or lower. The haze can be measured by a method in conformity with JIS K 7136, for example, with a device such as a turbidity meter “Haze Meter NDH2000” available form Nippon Denshoku Industries Co., Ltd.

The transparent base 113 can be, for example, a glass plate or a resin plate such as an acrylic plate or a polycarbonate plate. The transparent base 113 may have a flat surface or a curved surface.

When being placed closer to the viewer side than the semi-transparent component 111 is as shown in FIG. 2, the transparent base 113 can prevent the semi-transparent component 111 from being scratched. Although the transparent base 113 creates senses of depth and luster when placed closer to the viewer side than the semi-transparent component 111 is, the senses of depth and luster may spoil the texture of the semi-transparent component 111 in some cases depending on the pattern of the semi-transparent component 111. To express the texture of the semi-transparent component 111 more vibrantly, the transparent base 113 is preferably placed closer to the back surface side than the semi-transparent component 111 is. On the other hand, when the semi-transparent component 111 is placed closer to the viewer side than the transparent base 113 is, the semi-transparent component 111 is more vulnerable to scratches. Thus, a hard coat layer (not shown) may further be placed closer to the viewer side than the semi-transparent component 111 is.

The hard coat layer is preferably one with high transparency and high scratch resistance. Examples include coating layers such as acrylic resin layers and epoxy resin layers. The transmittance of the hard coat layer is preferably 90% or higher, for example.

### (Display Panel)

As shown in FIG. 1, the display panel 100 in a plan view may include a display region and a frame region surrounding the display region. In FIG. 1, the dotted line indicates the boundary between the display region and the frame region of the display panel. The outer edge of the black matrix 23 inside the display panel shown in FIG. 2 defines the boundary between the display region and the frame region. The display region is a region that includes pixels and displays the desired image or the like during transmissive display. The frame region is a region that overlaps the enclosure and the bezel and has no involvement in transmissive display.

The display panel 100 preferably includes the second linear polarizer 51 placed closer to the viewer side. The second linear polarizer 51 can be a linear polarizer similar to the first linear polarizer 112. The second linear polarizer 51 may be a linear polarizer that includes a polarizing film including dichroic molecules and a pair of protective films between which the polarizing film including dichroic molecules is held.

The display panel 100 may be any display panel that provides transmissive display by emitting display light to the viewer side, and may be a liquid crystal panel or a self-luminous panel such as a light emitting diode (LED) panel including LEDs.

The following shows a case where the display panel 100 is a liquid crystal panel. As shown in FIG. 2, the liquid crystal panel may include the second linear polarizer 51 placed closer to the viewer side and include a third linear polarizer 52 placed closer to the back surface side. The second and third linear polarizers 51 and 52 are polarizers that transmit only light polarized in a specific direction. The linear polarizer may be an absorptive linear polarizer including a transmission axis that transmits only light polarized in a specific direction and an absorption axis that is orthogonal to the transmission axis. The second and third linear polarizers 51 and 52 are preferably arranged with their transmission axes being orthogonal to each other.

The third linear polarizer 52 can be a linear polarizer similar to the first linear polarizer 112. The second and third linear polarizers 51 and 52 can be known polarizers such as “TEG1465DU” available from Nitto Denko Corporation.

Although not shown, the second linear polarizer 51 may be attached by a transparent adhesive to the surface of the TFT substrate 10 opposite to the liquid crystal layer 30, and the third linear polarizer 52 may be attached by a transparent adhesive to the surface of the CF substrate 20 opposite to the liquid crystal layer 30.

Examples of the liquid crystal panel include those including a first substrate, a second substrate, and a liquid crystal layer held between the first and second substrates. The first substrate may be the TFT substrate 10 including switching elements such as thin film transistors (TFTs), and the second substrate may be a color filter (CF) substrate 20 including color filters. The TFT substrate 10 and the CF substrate 20 are attached to each other by a sealant 40 and the liquid crystal layer 30 is sealed between the substrates.

Although not shown, an example of the configuration of the TFT substrate 10 is one including, on a supporting substrate, gate lines and source lines crossing the gate lines, TFTs placed at or near the intersections of the gate lines and the source lines, and pixel electrodes electrically connected to the TFTs. Each region surrounded by gate lines and source lines is a pixel.

The pixel electrodes and the later-described counter electrode may be transparent electrodes, and can be made of, for example, a transparent conductive material such as indium tin oxide (ITO), indium zinc oxide (IZO), zinc oxide (ZnO), or tin oxide (SnO), or an alloy of any of these materials.

The color filter substrate 20, for example, may include on a supporting substrate 21 a color filter layer 22 and a black matrix 23. The color filter layer 22 may include red, green, and blue color filters. Each color filter overlaps a pixel of the TFT substrate. The desired color can be expressed by mixing colors while controlling the amounts of lights transmitted through the color filters of different colors.

The black matrix 23 in a plan view may be placed to partition the color filters. The color filters and the black matrix are not limited and may each be one known in the field of liquid crystal panels.

The supporting substrates used in the TFT substrate 10 and the CF substrate 20 are preferably transparent substrates, such as glass substrates or plastic substrates.

The display mode of the liquid crystal panel may be the vertical electric field mode or the transverse electric field mode. Examples of the vertical electric field mode include the vertical alignment (VA) mode where with no voltage applied, the liquid crystal molecules in the liquid crystal layer are aligned substantially perpendicularly to the substrate surfaces. Examples of the transverse electric field mode include the fringe field switching (FFS) mode and the in-plane-switching (IPS) mode where with no voltage applied, the liquid crystal molecules in the liquid crystal layer are aligned substantially horizontally to the substrate surfaces. The state with no voltage applied incudes cases where voltage lower than the threshold for the liquid crystal molecules is applied to the liquid crystal layer.

The expression “substantially horizontally” means that the tilt angle is 0° or greater and 10° or smaller, preferably 0° or greater and 5° or smaller, more preferably 0° or greater and 2° or smaller. The expression “substantially perpendicularly” means that the tilt angle is 830 or greater and 90° or smaller, preferably 850 or greater and 90° or smaller, more preferably 87.5° or greater and 88.0° or smaller.

The liquid crystal layer 30 controls the amount of light transmitted therethrough using its liquid crystal molecules whose alignment changes according to the electric field generated inside the liquid crystal layer 30 in response to the voltage applied between the pixel electrode and the counter electrode. In the vertical electric field mode, the counter electrode is placed in the TFT substrate while in the transverse electric field mode, the counter electrode is placed in the CF substrate.

The anisotropy of dielectric constant (Δε), defined by the following formula (L), of the liquid crystal molecules may be positive or negative.

Δε=(dielectric constant in long axis direction)−(dielectric constant in short axis direction) (L)

Although not shown, alignment films controlling the alignment azimuth of the liquid crystal molecules with no voltage applied may be placed, one between the TFT substrate 10 and the liquid crystal layer 30 and one between the CF substrate 20 and the liquid crystal layer 30. The alignment film can be made of a material commonly used in the field of liquid crystal panels, such as a polymer having a polyimide, polyamic acid, or polysiloxane main chain structure.

### (Backlight)

The display device according to Embodiment 1 may further include a backlight 200 closer to the back surface side than the display panel 100 is. The backlight 200 can be a known one and may be, for example, an edge-lit backlight including light sources on the end surfaces of a light guide plate or a direct-lit backlight including light sources on its surface and increasing the uniformity of light using a diffuser, for example.

### (Enclosure)

The display device according to Embodiment 1 may further include an enclosure 300 that houses the display panel 100 and the optical film 110A. Double-sided tape 301 may be placed on the back surface side surface of the optical film 110A overlapping the frame region to fix the optical film 110A to the enclosure 300. The enclosure 300 may include inside, for example, a circuit substrate (not shown) on which drive circuits that drive the display panel 100 and the backlight 200 are formed. The enclosure 300 may be any enclosure that can house the display panel 100 and the optical film 110A and may be made of a metal or resin. The shape of the enclosure 300 is not limited to the shape shown in FIG. 2.

### (Description of Display Method of Display Device)

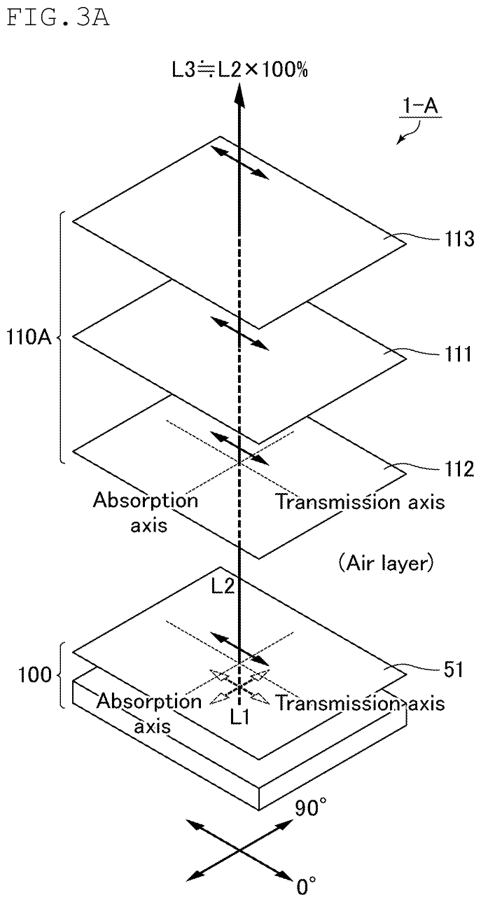

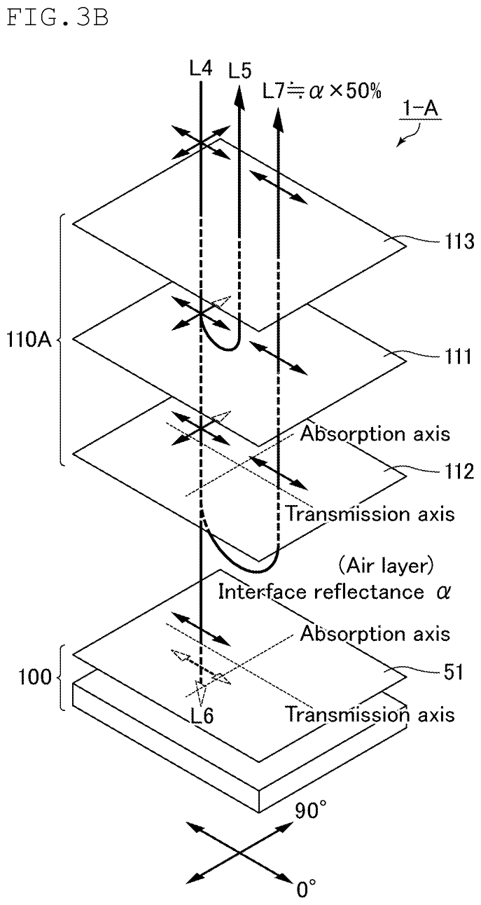

The following shows the display method of the display device according to Embodiment 1 with reference to FIG. 3A and FIG. 3B. FIG. 3A is an explanatory diagram showing transmissive display provided by the display device according to Embodiment 1. FIG. 3B is an explanatory diagram showing reflective display provided by the display device according to Embodiment 1.

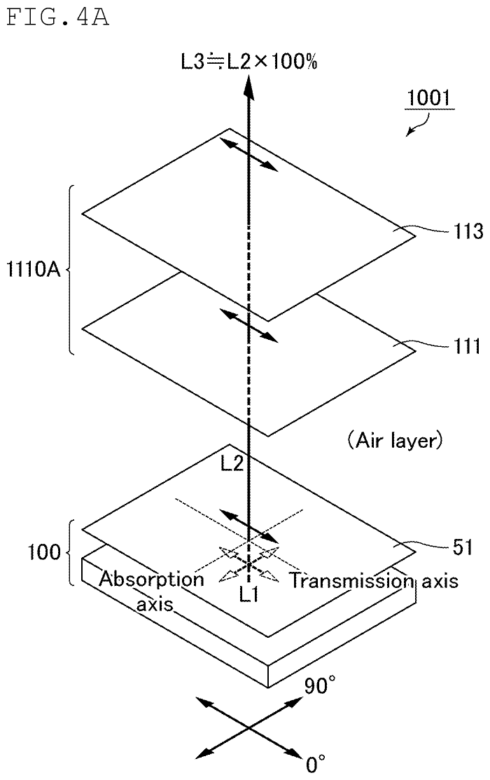

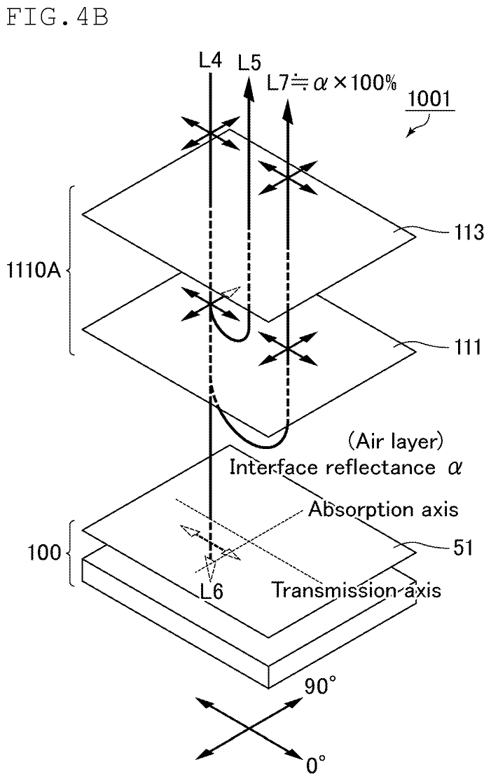

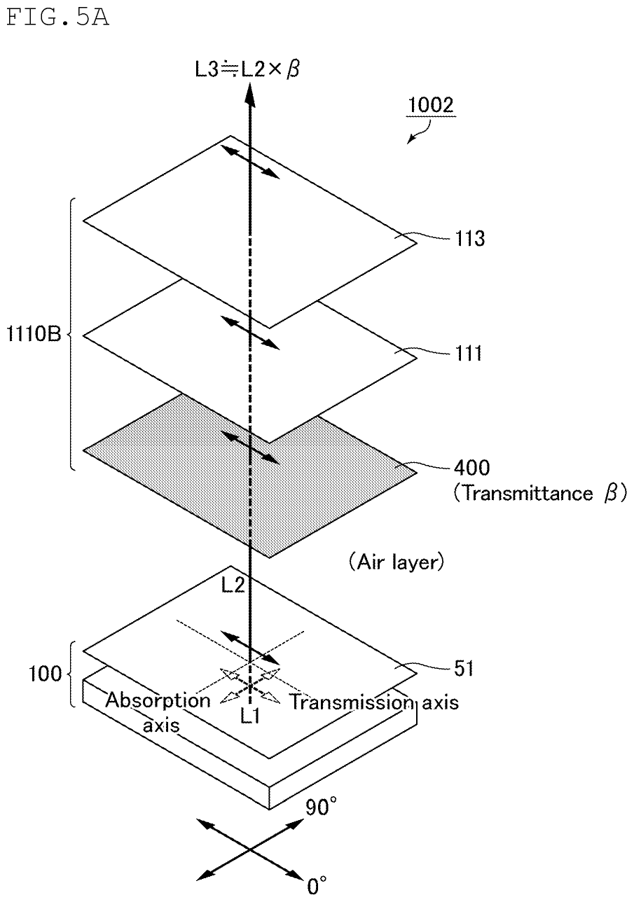

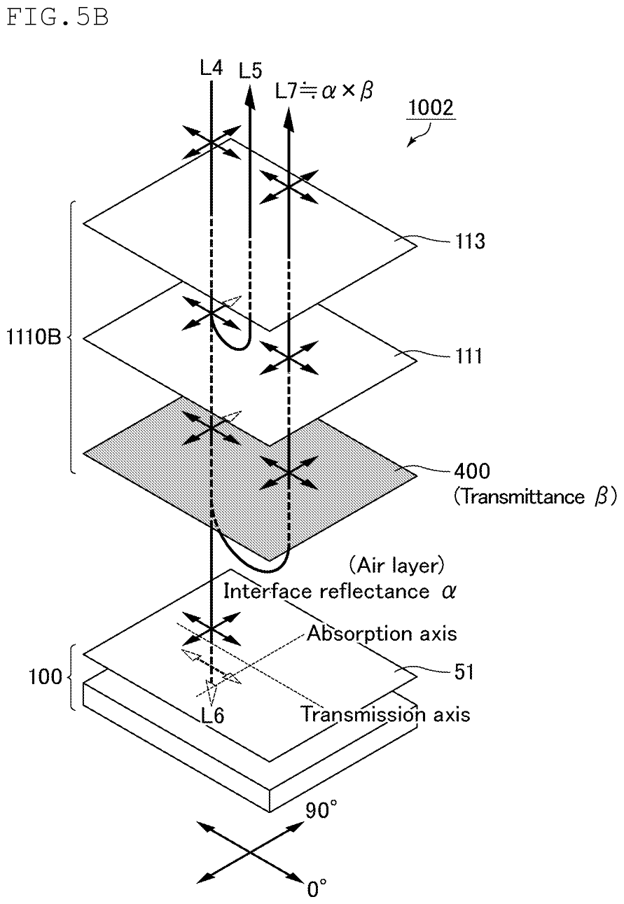

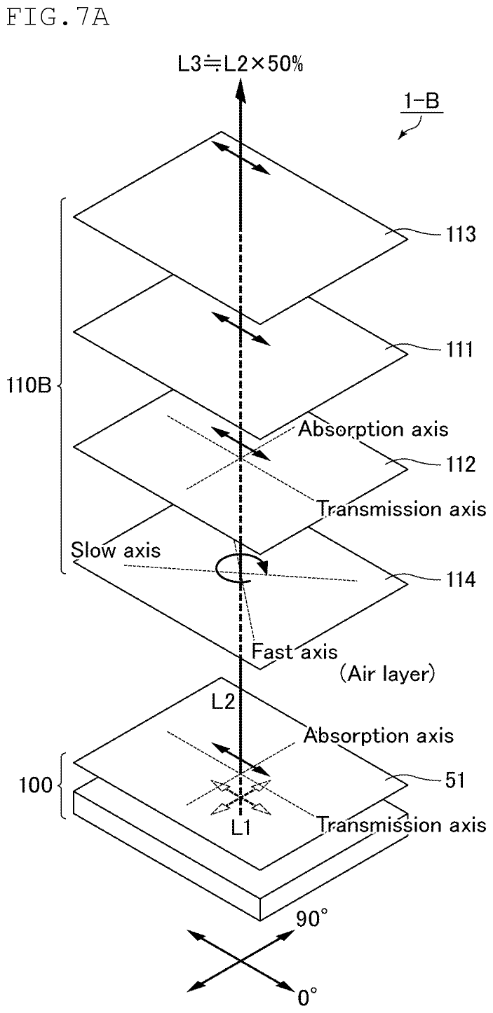

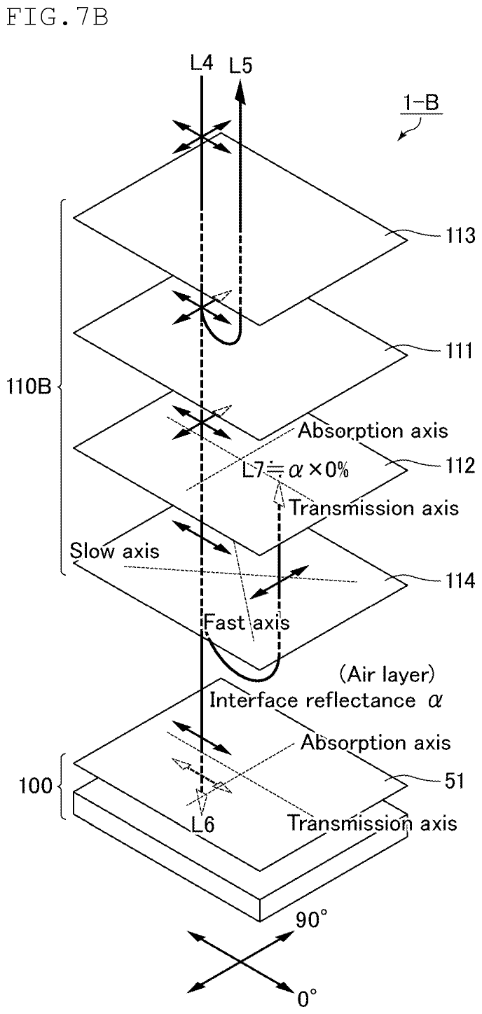

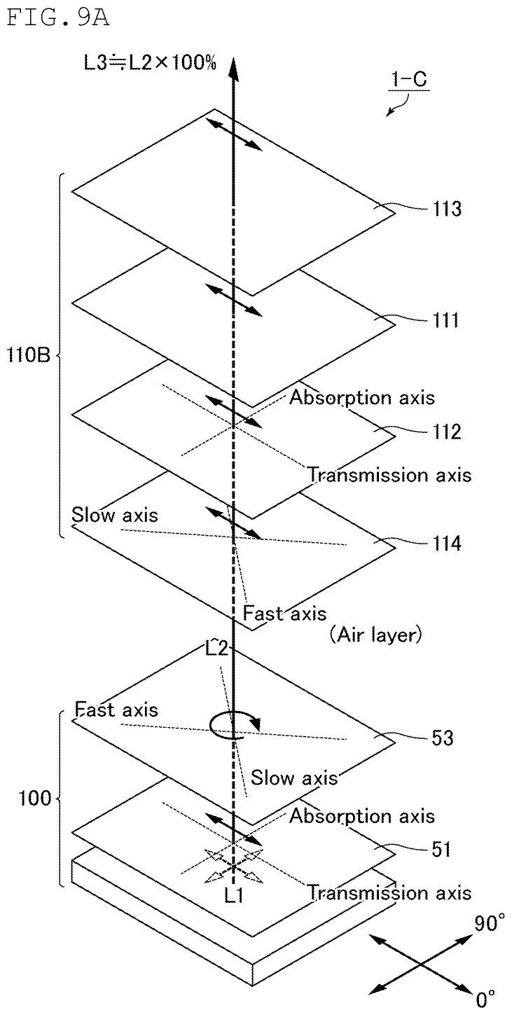

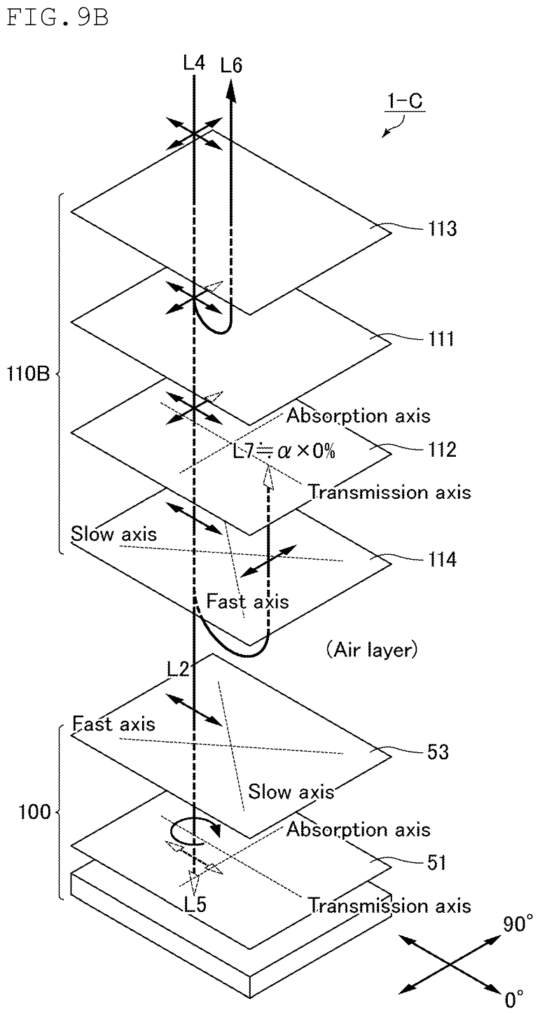

In FIG. 3A, FIG. 3B, and the later-described FIG. 4A, FIG. 4B, FIG. 5A, FIG. 5B, FIG. 7A, FIG. 7B, FIG. 9A, and FIG. 9B, a double-headed arrow pointing one direction and a double-headed arrow orthogonal thereto each represent the polarization state of light; the double-headed arrow pointing one direction represents linearly polarized light vibrating in the one direction, and the double-headed arrow orthogonal thereto represents unpolarized light. In the explanatory diagrams, the direction X2 in a cross-sectional view of the display device is taken as the direction at 0°.

The display device 1-A according to Embodiment 1 can provide reflective display and transmissive display. Herein, reflective display means a display method that uses reflection of light (ambient light) incident on the display device from the viewer side to cause the viewer to perceive the color and pattern of the colored semi-transparent component. Herein, transmissive display means a display method that causes light (display light) emitted from the display panel side to be transmitted through the front plate to the viewer side, thus causing the viewer to perceive an image or the like displayed on the display panel.

As shown in FIG. 3A, during transmissive display, light (display light) L1 emitted from the viewer side surface of the display panel 100 is transmitted through the second linear polarizer 51 placed closer to the viewer side than the display panel 100 is to be converted to linearly polarized light L2. The linearly polarized light is transmitted through the first linear polarizer 112, the semi-transparent component 111, and the transparent base 113 to be emitted toward the viewer. Since the transmission axis of the first linear polarizer 112 and the transmission axis of the second linear polarizer 51 are parallel to each other, light transmitted through the second linear polarizer 51 is hardly absorbed by the first linear polarizer 112, so that light L3 emitted toward the viewer is nearly equal to L2×100%. Here, the transmittance of the semi-transparent component 111 is not considered, and no optical element providing a phase difference that changes the polarization state of light is assumed to be present between the first linear polarizer 112 and the second linear polarizer 51. Ambient light reflection, which is described later, also occurs during transmissive display; still, when the quantity of light emitted from the display panel 100 side is sufficiently larger than the amount of ambient light, it is difficult for the viewer to perceive the color, pattern, and the like of the semi-transparent component 111 and thus the viewer can perceive an image or the like displayed on the display panel 100.

Next, reflective display is described. As shown in FIG. 3B, light incident on the display device from the viewer side is referred to as ambient light L4. Part of L4 is transmitted through the transparent base 113, reflected by the semi-transparent component 111, and emitted toward the viewer (L5). Other part of L4 is transmitted through the semi-transparent component 111 and the first linear polarizer 112, incident on the display panel 100 (including the second linear polarizer 51), and absorbed by the color filters and other internal components of the display panel 100 (L6). Part of light transmitted through the optical film 110A (transparent base 113, semi-transparent component 111, and first linear polarizer 112) undergoes interface reflection in the air layer between the optical film 110A and the display panel 100 to be emitted toward the viewer (L7). When the interface reflectance in the interface between the optical film 110A and the air layer is taken as a %, the proportion of light L7 emitted toward the viewer to the light from the interface reflection is about α%×50% since L7 is transmitted through the first linear polarizer 112. There are also light reflected by the surface of the transparent base 113 and internally reflected light internally reflected by components such as conductive lines and electrodes constituting the display panel 100 and emitted again toward the viewer. Here, description of such lights is omitted.

The transmittance of the semi-transparent component 111 varies depending on the pattern formed on the semi-transparent component 111, but is about 60% to about 80%, for example. The transmittance of the semi-transparent component 111 can be measured, for example, with spectrophotometer CM-5 available from Konica Minolta Japan, Inc.

As described above, the display device 1-A includes no smoke layer and includes the first linear polarizer 112 being placed closer to the back surface side than the semi-transparent component 111 is and being integrated with the semi-transparent component 111. When the transmission axis of the first linear polarizer 112 and the transmission axis of the second linear polarizer 51 in the display panel 100 are parallel to each other, a high luminance can be achieved more effectively during transmissive display. Also, about 50% of interface-reflected light from ambient light reflected in the interface between the optical film 110A and the air layer is absorbed by the first linear polarizer 112. In this manner, the display device 1-A can achieve both bright transmissive display and vivid reflective display.

### Comparative Embodiment 1

Hereinafter, the display method of a display device 1001 according to Comparative Embodiment 1 is described with reference to FIG. 4A and FIG. 4B. FIG. 4A is an explanatory diagram showing transmissive display provided by a display device according to Comparative Embodiment 1. FIG. 4B is an explanatory diagram showing reflective display provided by the display device according to Comparative Embodiment 1. The display device 1001 according to Comparative Embodiment 1 has a similar configuration to the display device 1-A, except that an optical film 1110A includes no polarizer (first linear polarizer 112).

As shown in FIG. 4A, during transmissive display, light (display light) L1 emitted from the viewer side surface of the display panel 100 is transmitted through the second linear polarizer 51 to be converted to linearly polarized light L2, transmitted through the semi-transparent component 111 and the transparent base 113, and emitted toward the viewer. When the transmittance of the semi-transparent component 111 is not considered and the optical film 1110A includes no optical element providing a phase difference that changes the polarization state, light L3 emitted toward the viewer is nearly equal to L2×100%.

Next, reflective display is described. Light L5 reflected by the semi-transparent component 111 is similar to that in the case of the display device 1-A, and description thereof is thus omitted. Description of light L6, which results from absorption of ambient light L4 by the internal components of the display panel 100, is also omitted. As shown in FIG. 4B, part of ambient light L4 transmitted through the optical film 1110A (transparent base 113 and semi-transparent component 111) undergoes interface reflection in the air layer between the optical film 1110A and the display panel 100 and emitted toward the viewer (L7). Since the optical film 1110A in the display device 1001 according to Comparative Embodiment 1 includes no polarizer, interface-reflected light is not absorbed, so that the proportion of light L7 emitted toward the viewer to the interface-reflected light is about interface reflectance α%×100%.

The following Table 1 shows the luminance during transmissive display and the proportion of light emitted toward the viewer to the interface-reflected light, measured on the display device 1-A according to Embodiment 1 and the display device 1001 according to Comparative Embodiment 1.

TABLE 1

| | Luminance during | Proportion of light emitted |
|---|---|---|
| | transmissive | toward viewer to interface- |
| | display | reflected light |
| Embodiment 1 | L2 × 100% | Interface reflectance α% × |
| (display device 1-A) | | 50% |
| Comparative | L2 × 100% | Interface reflectance α% × |
| Embodiment 1 | | 100% |
| (display device 1001) | | |

As shown in Table 1, during transmissive display, the display device 1001 according to Comparative Embodiment 1 with the optical film including no polarizer can achieve brightness equivalent to that achieved by the display device 1-A according to Embodiment 1. During reflective display, however, the display device 1001 according to Comparative Embodiment 1, which has a higher proportion of light emitted toward the viewer to the interface-reflected light than the display device 1-A, causes the color and pattern of the semi-transparent component 111 to appear whitish, not vivid.

### Comparative Embodiment 2

Hereinafter, the display method of a display device 1002 according to Comparative Embodiment 2 is described with reference to FIG. 5A and FIG. 5B. FIG. 5A is an explanatory diagram showing transmissive display provided by a display device according to Comparative Embodiment 2. FIG. 5B is an explanatory diagram showing reflective display provided by the display device according to Comparative Embodiment 2. The display device 1002 according to Comparative Embodiment 2 has a similar configuration to the display device 1-A according to Embodiment 1, except that an optical film 1110B includes a smoke layer 400, instead of a polarizer, placed closer to the back surface side than the semi-transparent component 111 is.

The smoke layer 400 can be formed by coating the back surface side surface of the front surface plate with a resin composition obtained by mixing a transparent resin with a black pigment, for example. The transmittance B of the smoke layer 400 can be adjusted by changing the amount of the black pigment added, and is 70% or lower, for example.

As shown in FIG. 5A, during transmissive display, light (display light) L1 emitted from the viewer side surface of the display panel 100 is transmitted through the smoke layer 400, the semi-transparent component 111, and the transparent base 113, and emitted toward the viewer. When the transmittance of the semi-transparent component 111 is not considered, the optical film 1110B includes no optical element providing a phase difference that changes the polarization state of light, and the transmittance of the smoke layer 400 is taken as β%, the luminance of light L3 emitted toward the viewer is about L2×β %.

Next, reflective display is described. Light L5 reflected by the semi-transparent component 111 is similar to that in the case of the display device 1-A, and description thereof is thus omitted. Description of light L6, which results from absorption of ambient light L4 by the internal components of the display panel 100, is also omitted. As shown in FIG. 5B, part of ambient light L4 transmitted through the optical film 1110B (transparent base 113, semi-transparent component 111, and smoke layer 400) undergoes interface reflection in the air layer between the optical film 1110B and the display panel 100 and emitted toward the viewer (L7). Since part of interface-reflected light is absorbed by the smoke layer 400 in the display device 1002 according to Comparative Embodiment 2, the proportion of light L7 emitted toward the viewer to the interface-reflected light is about interface reflectance α%×β%.

The following Table 2 shows the luminance during transmissive display and the proportion of light emitted toward the viewer to the interface-reflected light, measured on the display device 1-A according to Embodiment 1, the display device 1001 according to Comparative Embodiment 1, and the display device 1002 according to Comparative Embodiment 2.

TABLE 2

| | Luminance during | Proportion of light emitted |
|---|---|---|
| | transmissive | toward viewer to interface- |
| | display | reflected light |
| Embodiment 1 | L2 × 100% | Interface reflectance α% × |
| (display device 1-A) | | 50% |
| Comparative | L2 × 100% | Interface reflectance α% × |
| Embodiment 1 | | 100% |
| (display device 1001) | | |
| Comparative | L2 × β% | Interface reflectance α% × |
| Embodiment 2 | | β% |
| (display device 1002) | | |

As shown in Table 2, during transmissive display, the display device 1002 according to Comparative Embodiment 2 with the optical film including the smoke layer instead of the polarizer has a lower luminance than the display device 1-A. During reflective display, however, the display device 1002 according to Comparative Embodiment 2 has a lower proportion of light emitted toward the viewer to the interface-reflected light than the display device 1001 according to Comparative Embodiment 1, and thus achieves more vivid reflective display than the display device 1001 according to Comparative Embodiment 1.

### Embodiment 2

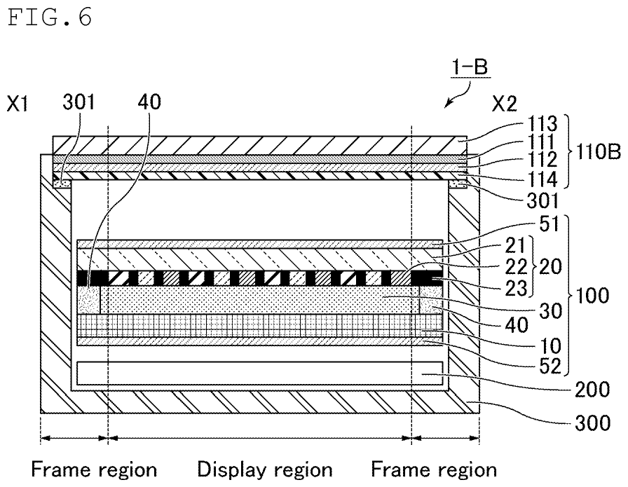

FIG. 6 is a schematic cross-sectional view of an example of a display device according to Embodiment 2. As shown in FIG. 6, in a display device 1-B according to Embodiment 2, an optical film 110B further includes a first λ/4 waveplate 114 on the surface (back surface side surface) of the first linear polarizer 112 opposite to the surface on which the semi-transparent component 111 is placed. The display device 1-B can cause the laminate of the first linear polarizer 112 and the first λ/4 waveplate 114 to function as a circular polarizer, thus converting incident light to circularly polarized light. The display device has a similar configuration to that in Embodiment 1, except that the optical film includes a first λ/4 waveplate. Thus, description of the configuration already described above is omitted.

The first λ/4 waveplate may be any waveplate that provides a phase difference of a quarter of a wavelength to incident light having a wavelength A. The first λ/4 waveplate, for example, is a phase difference plate that provides an in-plane phase difference of a quarter of a wavelength (precisely, 137.5 nm), preferably an in-plane phase difference of 120 nm or more and 150 nm or less, to light with a wavelength of 550 nm.

The first λ/4 waveplate may have a fast axis and a slow axis orthogonal to the fast axis. The transmission axis of the first linear polarizer and the slow axis of the first λ/4 waveplate may form an angle of substantially 45°. Herein, an angle of substantially 45° is an angle falling preferably within the range of 45°±3°, more preferably within the range of 45°±1°, still more preferably within the range of 45°±0.5°.

Hereinbelow, the display method of the display device 1-B according to Embodiment 2 is described with reference to FIG. 7A and FIG. 7B. FIG. 7A is an explanatory diagram showing transmissive display provided by the display device according to Embodiment 2. FIG. 7B is an explanatory diagram showing reflective display provided by the display device according to Embodiment 2.

As shown in FIG. 7A, during transmissive display, light (display light) L1 emitted from the viewer side surface of the display panel 100 is transmitted through the second linear polarizer 51 to be converted to linearly polarized light L2, transmitted through the first λ/4 waveplate 114 to be converted to circularly polarized light, transmitted through the first linear polarizer 112 to be converted to linearly polarized light, transmitted through the semi-transparent component 111 and the transparent base 113, and emitted toward the viewer (L3). At this time, about 50% of the circularly polarized light transmitted through the first λ/4 waveplate 114 is absorbed by the first linear polarizer 112. When the transmittance of the semi-transparent component 111 is not considered and the optical film 110B includes no optical element providing a phase difference that changes the polarization state of light in addition to the first linear polarizer 112 and the first λ/4 waveplate 114, light L3 emitted toward the viewer is about L2×50%.

Next, reflective display is described. Light L5 reflected by the semi-transparent component 111 is similar to that in the case of the display device 1-A, and description thereof is thus omitted. Description of light L6, which results from absorption of ambient light L4 by the internal components of the display panel 100, is also omitted. As shown in FIG. 7B, part of ambient light L4 transmitted through the optical film 110B (transparent base 113, semi-transparent component 111, first linear polarizer 112, and first λ/4 waveplate 114) undergoes interface reflection in the air layer between the optical film 110B and the display panel 100. The interface-reflected light enters the first λ/4 waveplate 114 again to be converted to linearly polarized light whose polarization axis direction is rotated 90°, and is then mostly absorbed by the first linear polarizer 112. Thus, in the display device 1-B, the interface-reflected light L7 is not emitted toward the viewer.

The following Table 3 shows the luminance during transmissive display and the proportion of light emitted toward the viewer to the interface-reflected light, measured on the display device 1-A according to Embodiment 1 and the display device 1-B.

TABLE 3

| | Luminance during | Proportion of light emitted |
|---|---|---|
| | transmissive | toward viewer to interface- |
| | display | reflected light |
| Embodiment 1 | L2 × 100% | Interface reflectance α% × |
| (display device 1-A) | | 50% |
| Embodiment 2 | L2 × 50% | Interface reflectance α% × |
| (display device 1-B) | | 0% |

As shown in Table 3, the display device 1-B, with the optical film further including the λ/4 waveplate closer to the back surface side than the first linear polarizer is, has a lower luminance during transmissive display than the display device 1-A is. Still, since the interface-reflected light during reflective display is not emitted toward the viewer, the display device 1-B can provide very vivid reflective display.

### Embodiment 3

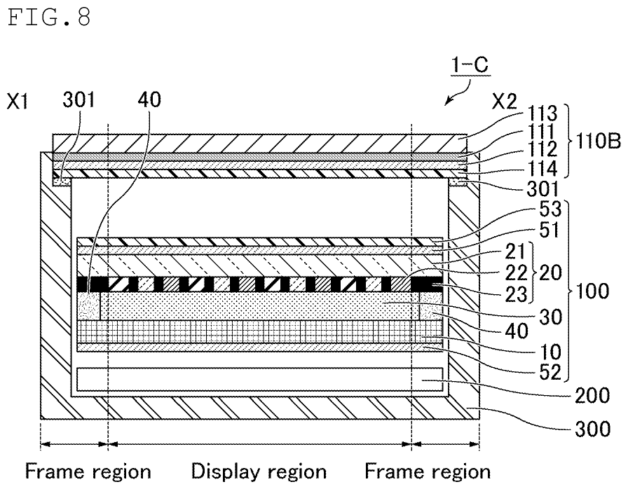

FIG. 8 is a schematic cross-sectional view showing an example of a display device according to Embodiment 3. As shown in FIG. 8, in a display device 1-C according to Embodiment 3, the display panel 100 includes a second λ/4 waveplate 53 and a second linear polarizer 51 sequentially from the viewer side. The display device 1-C has a similar configuration to that in Embodiment 2, except that the display panel includes the second λ/4 waveplate 53. Thus, description of the configuration already described above is omitted. The transmission axis of the second linear polarizer 51 and the slow axis of the second λ/4 waveplate 53 form an angle of substantially 45°, and the slow axis of the first λ/4 waveplate 114 and the slow axis of the second λ/4 waveplate 53 are preferably orthogonal to each other.

Hereinbelow, the display method of the display device 1-C according to Embodiment 3 is described with reference to FIG. 9A and FIG. 9B. FIG. 9A is an explanatory diagram showing transmissive display provided by the display device according to Embodiment 3. FIG. 9B is an explanatory diagram showing reflective display provided by the display device according to Embodiment 3.

As shown in FIG. 9A, during transmissive display, light (display light) L1 emitted from the viewer side surface of the display panel 100 is transmitted through the second linear polarizer 51 and the second λ/4 waveplate 53 to be converted to circularly polarized light L2, transmitted through the first λ/4 waveplate 114 to be converted to linearly polarized light, transmitted through the first linear polarizer 112, the semi-transparent component 111, and the transparent base 113, and emitted toward the viewer (L3). At this time, almost 100% of the linearly polarized light transmitted through the first λ/4 waveplate 114 is transmitted through the first linear polarizer 112. When the transmittance of the semi-transparent component 111 is not considered and the optical film 110B includes no optical element providing a phase difference that changes the polarization state of light in addition to the first linear polarizer 112 and the first λ/4 waveplate 114, light L3 emitted toward the viewer is about L2×100%.

Next, reflective display is described. Light L5 reflected by the semi-transparent component 111 is similar to that in the case of the display device 1-A, and description thereof is thus omitted. Description of light L6, which results from absorption of ambient light L4 by the internal components of the display panel 100, is also omitted. As shown in FIG. 9B, as in Embodiment 2, part of ambient light L4 transmitted through the optical film 110B undergoes interface reflection in the air layer between the optical film 110B and the display panel 100, and the resulting interface-reflected light enters the first λ/4 waveplate 114 to be converted to light whose polarization axis direction is rotated 90°, and is then mostly absorbed by the first linear polarizer 112. Thus, in the display device 1-C, the interface-reflected light L7 is not emitted toward the viewer.

The following Table 4 shows the luminance during transmissive display and the proportion of light emitted toward the viewer to the interface-reflected light, measured on the display device 1-A according to Embodiment 1 and the display device 1-C according to Embodiment 3.

TABLE 4

| | Luminance during | Proportion of light emitted |
|---|---|---|
| | transmissive | toward viewer to interface- |
| | display | reflected light |
| Embodiment 1 | L2 × 100% | Interface reflectance α% × |
| (display device 1-A) | | 50% |
| Embodiment 3 | L2 × 100% | Interface reflectance α% × |
| (display device 1-C) | | 0% |

As shown in Table 4, the display device 1-C with the optical film further including the λ/4 waveplate placed closer to the back surface side than the first linear polarizer is and with the display panel including the λ/4 waveplate placed closer to the viewer side can provide very vivid reflective display since the luminance during transmissive display is as high as that of the display device 1-A and the interface-reflected light is not emitted toward the viewer during reflective display.

When the circular polarizer (combination of the first linear polarizer 112 and the first λ/4 waveplate 114) is placed closer to the viewer side than the display panel is, the transmittance can be suitably modulated. Thus, when the display panel is a liquid crystal panel, the display mode is more preferably a vertical electric field mode such as the VA mode than a transverse electric field mode such as the IPS mode.

When the circular polarizer (combination of the first linear polarizer 112 and the first λ/4 waveplate 114) is placed closer to the viewer side than the display panel is, the internal reflectance of the display panel can be reduced. Thus, when the display panel is a self-luminous panel such as an OLED panel which has a higher internal reflectance than a liquid crystal panel, vivid reflective display can be more effectively provided. The present embodiment is suitable particularly for cases where a self-luminous panel is used in a bright environment such as an outdoor environment.

The self-luminous panel is a panel that includes a light emitting element inside and can emit light by itself, thus being capable of emitting light toward the viewer without any external light source such as a backlight. The self-luminous panel can be a known one, such as an organic light emitting diode (OLED) panel including OLEDs.

The configuration of the light emitting diode is not limited, and may be, for example, a stack of a cathode, a light emitting layer, and an anode arranged in the stated order. When the light emitting element is an OLED, the light emitting layer may include a fluorescent material, a phosphorescent material, or another material as the light emitting material. An electron transport layer may be placed between the cathode and the light emitting layer. A hole transport layer may be placed between the light emitting layer and the anode.

Light emitting elements such as OLEDs may be arranged, for example, in a matrix pattern in the TFT substrate. In this case, light emitting elements may be placed for the respective TFTs arranged at or near the intersections of the gate lines and the source lines (in the respective pixels). The region in which the light emitting elements are placed defines the display region. The light emitting elements may include red light emitting elements, green light emitting elements, and blue light emitting elements.

### Embodiment 4

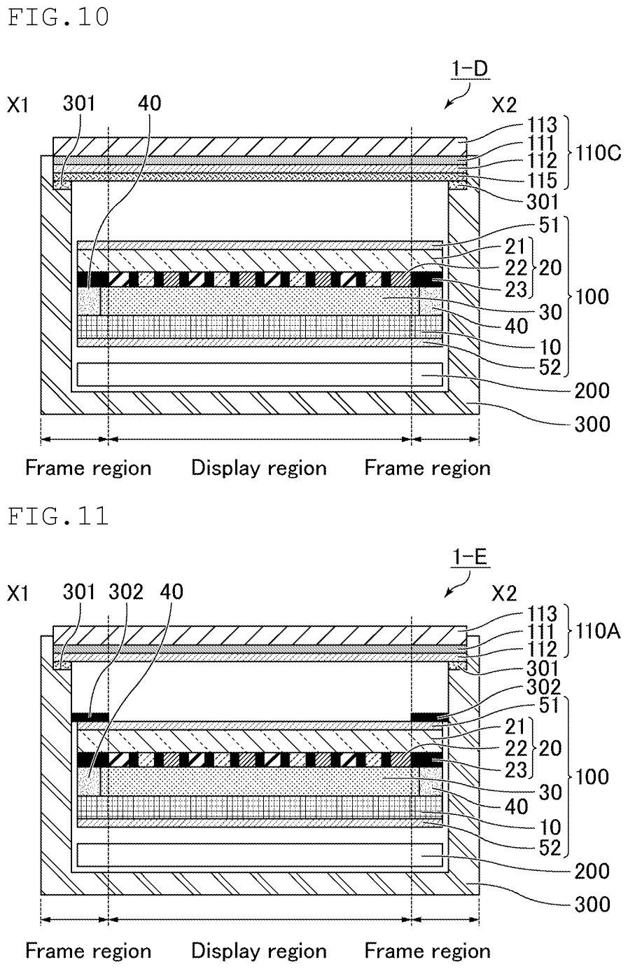

FIG. 10 is a schematic cross-sectional view showing an example of a display device according to Embodiment 4. As shown in FIG. 10, in a display device 1-D according to Embodiment 4, an optical film 110C further includes an antireflective layer 115 on the surface (back surface side surface) of the first linear polarizer 112 opposite to the surface on which the semi-transparent component 111 is placed. The display device has a similar configuration to that in Embodiment 1, except that the optical film includes the antireflective layer. Thus, description of the configuration already described above is omitted. With the optical film including the antireflective layer, the display device can more effectively reduce or prevent emission of interface-reflected light reflected in the air layer between the optical film and the display device toward the viewer, thus proving more vivid reflective display.

Examples of the antireflective layer include resin layers including a low-refractive index material and moth-eye films. The moth-eye films are films that can reduce or prevent reflection by continuously changing the incident light reflectance. Examples thereof include those having nanoscale fine irregularities on the surface of a film such as a transparent film regularly at intervals shorter than the wavelength of visible light. The antireflective layer can be, for example, MOSMITE available from Mitsubishi Chemical Corporation.

### Embodiment 5

FIG. 11 is a schematic cross-sectional view showing an example of a display device according to Embodiment 5. As shown in FIG. 11, in a display device 1-E according to Embodiment 5, the display panel 100 in a plan view includes a display region and a frame region surrounding the display region, and includes, in a plan view, light blocking components 302 in regions overlapping the frame region. The display device has a similar configuration to that in Embodiment 1, except that the display panel includes the light blocking components. Thus, description of the configuration already described above is omitted.

The display device can provide transmissive display as long as at least the second linear polarizer 51 in a plan view overlaps the display region of the display panel 100. The frame region, having no involvement in transmissive display, may therefore include regions not overlapping the second linear polarizer 51 in a plan view. The regions included in the frame region and not overlapping the second linear polarizer 51 may be seen through during reflective display or may reflect ambient light to cause stray light. Placing the light blocking components 302 in these regions overlapping the frame region in a plan view can reduce or prevent occurrence of the see-through regions and occurrence of stray light to make reflective display vivid. The light blocking components 302 are preferably not placed in any region overlapping the display region in a plan view.

The light blocking components 302 may be made of the same material as the black matrix 23, and may be formed using a material such as a black pigment by printing such as screen printing. Black tape may also be used.

### Embodiment 6

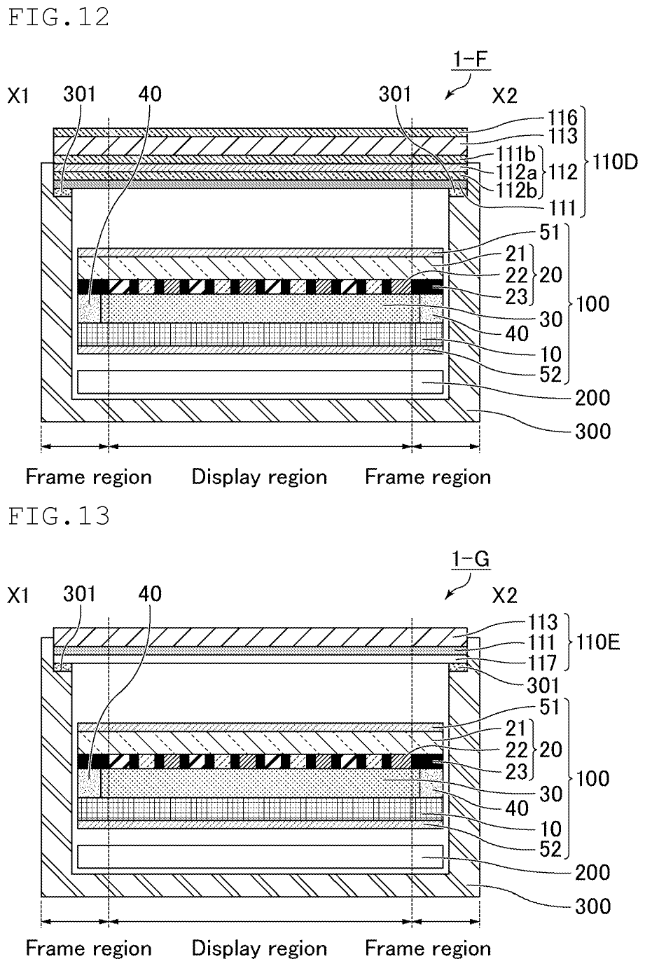

FIG. 12 is a schematic cross-sectional view showing an example of a display device according to Embodiment 6. As shown in FIG. 12, in a display device 1-F according to Embodiment 6, the first linear polarizer 112 is a linear polarizer including a polarizing film 112a including dichroic molecules and a pair of protective films 112b between which the polarizing film 112a including dichroic molecules is held. In addition, as shown in FIG. 12, an optical film 110D further includes a transparent film 116 on the surface (viewer side surface) opposite to the surface on which the first linear polarizer 112 is placed.

When the first linear polarizer is a polarizer in which a polarizing film is held between protective films, the optical film 110D may warp depending on the pressure applied to attach the first linear polarizer 112 to the transparent base 113 and/or the difference in coefficient of linear expansion between the transparent base 113 and the protective films 112b. In Embodiment 6, the transparent film 116 whose coefficient of linear expansion is of the same level as that of the protective films 112b is attached to the viewer side surface of the optical film 110D, so that warpage of the optical film 110D can be reduced or prevented.

In the display device 1-F, the difference in coefficient of linear expansion between the transparent film 116 and one of the protective films 112b is 30×10⁻⁶/K or less. This configuration can effectively reduce or prevent warpage of the optical film 110D. The difference in coefficient of linear expansion between the transparent film 116 and one of the protective films 112b is more preferably 50×10⁻⁶/K or less.

The polarizing film 112a including dichroic molecules and the protective films 112b may be ones similar to those used in Embodiment 1.

Examples of the transparent film 116 include those mentioned as examples of the protective films, including cellulose-based resin films such as triacetyl cellulose (TAC)-based resin films, polyester-based resin films, polyvinyl alcohol-based resin films, polycarbonate-based resin films, polyamide-based resin films, polyimide-based resin films, polyethersulfone-based resin films, polysulfone-based resin films, polystyrene-based resin films, polynorbornene-based resin films, polyolefin-based resin films, (meth)acrylic resin films, acetate-based resin films, and polyethylene terephthalate (PET) films. The transparent film 116 preferably has a transmittance of 90% or higher.

In Embodiment 6, the transparent film 116 is one having a difference in coefficient of linear expansion from the protective films 112b of 30×10⁻⁶/K or less, and may be a film made of the same material as or a different material from that of the protective films 112b. For example, when the protective films 112b are TAC films, the transparent film 116 may be a TAC film or a different film such as a polyethylene terephthalate (PET) film.

The thicknesses of the transparent film 116 and the protective films 112b may each be, for example, 50 μm to 200 μm. To reduce or prevent warpage of the optical film 110D, the thickness of the transparent film 116 and the thickness of each protective film 112b are preferably equal to each other, and the difference in thickness between the transparent film 116 and the protective films 112b is preferably 50 μm or less, for example.

When the transparent base 113 and each protective film 112b of the first linear polarizer 112 are attached to each other by an adhesive layer and the transparent base 113 and the transparent film 116 are attached to each other by another adhesive layer, for reduction or prevention of warpage of the optical film 110D, the thicknesses of the two adhesive layers are preferably equal to each other and may be from 5 μm to 50 μm, for example.

### Embodiment 7

FIG. 13 is a schematic cross-sectional view showing an example of a display device according to Embodiment 7. A display device 1-G according to Embodiment 7 includes an optical film 110E and a display panel placed closer to the back surface side than the optical film 110E is. The optical film 110E includes the colored semi-transparent component 111 and a louver film 117 being placed closer to the back surface side than the colored semi-transparent component 111 is and being integrated with the semi-transparent component 111. The display device has a similar configuration to that in Embodiment 1, except that the first linear polarizer is replaced by the louver film. Thus, description of the configuration already described above is omitted.

The louver film is a component that absorbs light incident thereon from a specific direction and is often used to prevent reflection of the screen on the windshield of a car. The louver film typically has a property of absorbing incident light from the top and bottom directions and transmitting light from the other directions. The louver film is often incorporated into a backlight, and the louver film in the present embodiment may be one used in the field of backlights. Use of a louver film instead of a first linear polarizer also enables provision of vivid reflective display. When the present embodiment is applied to a display device whose backlight originally includes a louver film, the luminance during transmissive display does not change. Since there is less need to strictly set the axes of the louver film than in the case of linear polarizers, the flexibility of design of the display device can be enhanced.

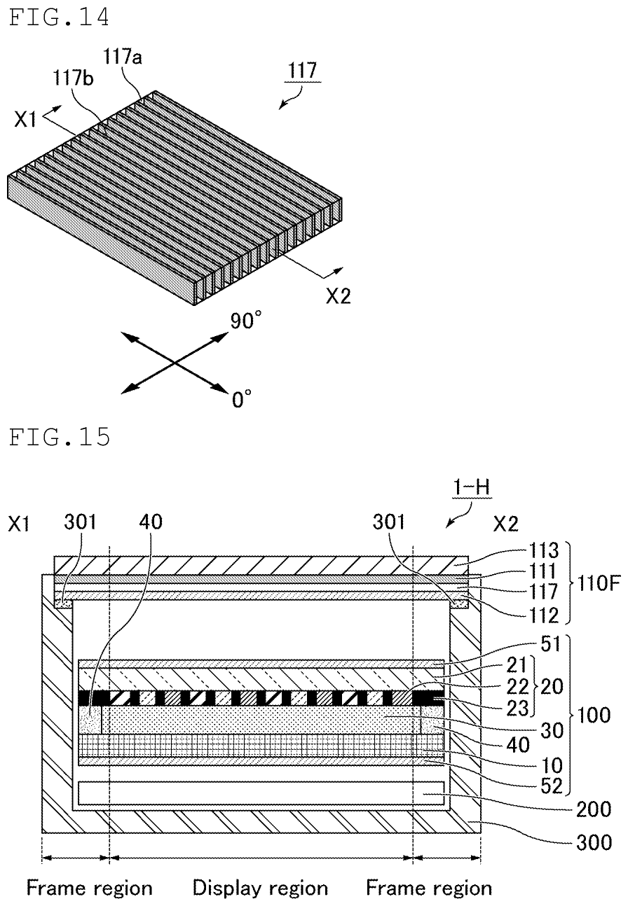

The louver film includes patterned light absorptive parts and light transmissive parts. FIG. 14 is a perspective view showing an example of a louver film. As shown in FIG. 14, an example of the patterned light absorptive parts and light transmissive parts may be, in a plan view, an arrangement where light transmissive parts 117a and light absorptive parts 117b alternate with each other. Examples of the louver film include N-VCF and W-VCF available from Shin-Etsu Polymer Co., Ltd.

In a plan view, the light absorptive parts 117b may be parallel to one another. The intervals of the light absorptive parts 117b can be adjusted or the angle of the light absorptive parts 117b to the direction normal to the optical film can be adjusted to adjust the viewing angle characteristics.

The light transmissive parts 117a may be made of a transparent resin, such as a polystyrene-based resin, polyolefin-based resin, polyvinyl chloride-based resin, polyurethane-based resin, polyester-based resin, polyamide-based resin, urethane resin, fluororesin, or silicone resin.

The light absorptive parts 117b may be made of a resin containing a colorant. Examples of the colorant include common organic or inorganic pigments, such as carbon black, tin oxide, titanium oxide, yellow iron oxide, disazo yellow, and phthalocyanine blue. The resin used for the light absorptive parts 117b may be the same as the transparent resin used for the light transmissive parts 117a.

### Embodiment 8

FIG. 15 is a schematic cross-sectional view showing an example of a display device according to Embodiment 8. As shown in FIG. 15, in a display device 1-H according to Embodiment 8, an optical film 110F includes the semi-transparent component 111, the louver film 117, and a linear polarizer in the stated order. This configuration enables the display device to provide more vivid reflective display than in Embodiment 7. Also, when the present embodiment is applied to a display device whose backlight originally includes a louver film, the luminance during transmissive display does not change.

In Embodiment 8, the linear polarizer can be the first linear polarizer mentioned as an example in Embodiment 1, or may be a linear polarizer including a polarizing film including dichroic molecules or a coating-type polarizing layer including dichroic molecules. The louver film can be the one mentioned as an example in Embodiment 7.

The louver film typically controls the emission direction without changing the polarization state of incident light. Yet, the resin of the light transmissive parts, for example, may more or less introduce a phase difference, so that when a laminate of the first linear polarizer and the louver film is used, as shown in FIG. 15, the semi-transparent component 111, the louver film 117, and the first linear polarizer 112 are preferably stacked in the stated order. The light transmission direction of the louver film 117 and the transmission axis of the first linear polarizer 112 are preferably parallel to each other.

### <<Optical Film>>

Another embodiment of the present invention is directed to an optical film including a colored semi-transparent component and a first linear polarizer or louver film being placed closer to the back surface side than the semi-transparent component is and being integrated with the semi-transparent component, the lover film including light absorptive parts and light transmissive parts arranged in a pattern, the semi-transparent component being configured to transmit part of light incident from the back surface side and reflect part of light incident from the viewer side. The optical film can be used as a component of a display device. When the optical film is used as a component of a display device, the colored semi-transparent component may be placed closer to the viewer side than the first linear polarizer is and a display panel may be placed closer to the back surface side than the first linear polarizer is.

### Embodiment 9

FIG. 16 is a schematic cross-sectional view showing an example of an optical film according to Embodiment 9. An optical film 110A according to Embodiment 9 is similar to that described for the display device 1-A according to Embodiment 1, and detailed description thereof is thus omitted. As shown in FIG. 16, the optical film 110A includes the colored semi-transparent component 111 integrated with the first linear polarizer 112.

In the present embodiment, the optical film includes the first linear polarizer, not the smoke layer, being placed closer to the back surface side than the colored semi-transparent component is. Thus, when a display panel is placed to face the first linear polarizer side of the optical film, vivid reflective display and bright transmissive display can be achieved.

The optical film 110A, as shown in FIG. 16, may include the transparent base 113 placed closer to the viewer side than the semi-transparent component 111 is. FIG. 17 is a schematic cross-sectional view showing another example of the optical film according to Embodiment 9. The optical film 110A, as shown in FIG. 17, may include the transparent base 113 placed closer to the back surface side than the semi-transparent component 111 is.

The semi-transparent component is a component transmitting part of light incident from the back surface side and reflecting part of light incident from the viewer side opposite to the back surface side, and is a colored semi-transparent component. The semi-transparent component has a transmittance of preferably 50% or higher, more preferably 70% or higher, for light incident from the back surface side. The upper limit of the transmittance of the semi-transparent component is, for example, 90%.

Examples of the semi-transparent component include metal thin films, films containing a pigment that reflects light, and print layers printed with a pigment that reflects light.

The first linear polarizer 112 is preferably an absorptive linear polarizer. The first linear polarizer may be the linear polarizer described above including the polarizing film including dichroic molecules and a pair of protective films between which the polarizing film including dichroic molecules is held, or the coating-type polarizing layer including dichroic molecules. The coating-type polarizing layer including dichroic molecules may be formed on the semi-transparent component.

### Embodiment 10

FIG. 18 is a schematic cross-sectional view showing an example of an optical film according to Embodiment 10. An optical film 110B according to Embodiment 10 is similar to that described for the display device 1-B according to Embodiment 2, and detailed description thereof is thus omitted. As shown in FIG. 18, the optical film 110B further includes the first λ/4 waveplate 114 on the surface of the first linear polarizer 112 opposite to the surface on which the semi-transparent component 111 is placed.

When the first linear polarizer 112 and the first λ/4 waveplate 114 are laminated, the laminate can function as a circular polarizer to convert incident light to circularly polarized light. Thus, when a display panel is placed to face the first linear polarizer side of the optical film, the interface-reflected light is not emitted toward the viewer during reflective display, so that very vivid reflective display can be provided.

The transmission axis of the first linear polarizer and the slow axis of the first λ/4 waveplate preferably form an angle of substantially 45°.

### Embodiment 11

FIG. 19 is a schematic cross-sectional view showing an example of an optical film according to Embodiment 11. An optical film 110C according to Embodiment 11 is similar to that described for the display device 1-D according to Embodiment 4, and detailed description thereof is thus omitted. As shown in FIG. 19, the optical film 110C further includes the antireflective layer 115 on the surface of the first linear polarizer 112 opposite to the surface on which the semi-transparent component 111 is placed.

With the antireflective layer, the optical film can more effectively reduce or prevent emission of the interface-reflected light reflected in the air layer between the optical film and the display device toward the viewer when a display panel is placed to face the first linear polarizer side of the optical film.

### Embodiment 12

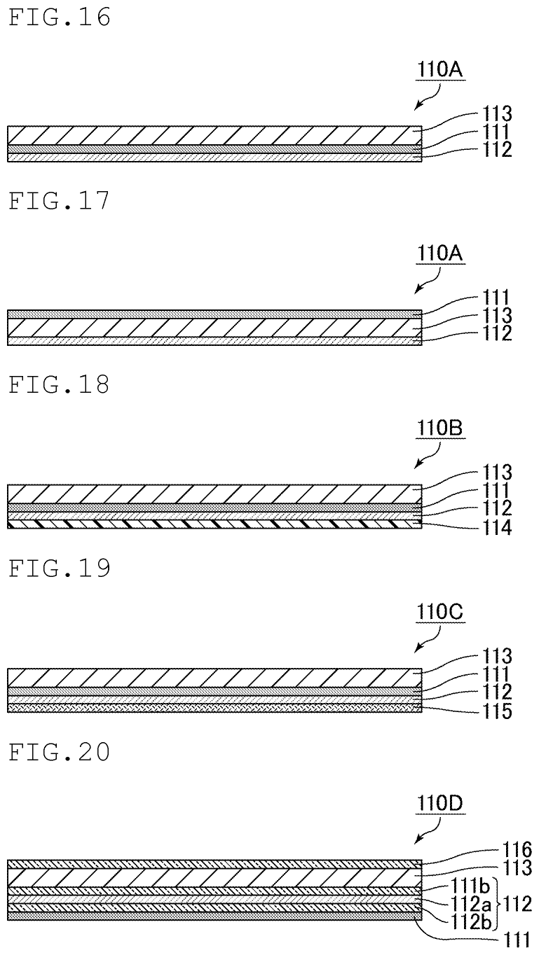

FIG. 20 is a schematic cross-sectional view showing an example of an optical film according to Embodiment 12. An optical film 110D according to Embodiment 12 is similar to that described for the display device 1-F according to Embodiment 6, and detailed description thereof is thus omitted. As shown in FIG. 20, the optical film 110D includes the first linear polarizer 112 which is a linear polarizer including the polarizing film 112a including dichroic molecules and the pair of protective films 112b between which the polarizing film 112a including dichroic molecules is held.

In addition, the optical film 110D further includes the transparent film 116 on the surface opposite to the surface on which the first linear polarizer 112 is placed, and the difference in coefficient of linear expansion between the transparent film 116 and one of the protective films 112b is 30×10⁻⁶/K or less. When the transparent film 116 whose coefficient of linear expansion is of the same level as that of the protective films is attached to the viewer side surface of the optical film 110D, warpage of the optical film 110D can be reduced or prevented.

### Embodiment 13

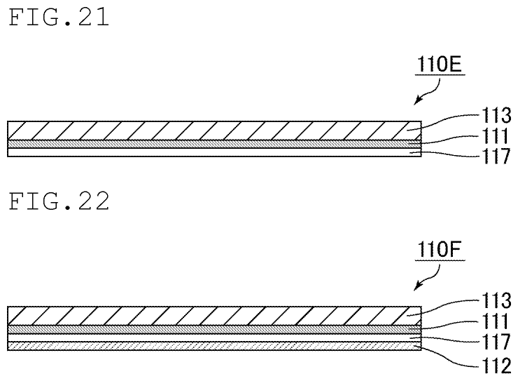

FIG. 21 is a schematic cross-sectional view showing an example of an optical film according to Embodiment 13. An optical film 110E according to Embodiment 13 is similar to that described for the display device 1-G according to Embodiment 7, and detailed description thereof is thus omitted. The optical film 110E includes the louver film 117 placed closer to the back surface side than the semi-transparent component is.

Use of the louver film instead of the first linear polarizer also enables provision of both bright transmissive display and vivid reflective display when a display panel is placed closer to the back surface side than the optical film is.

The louver film 117 may include in a plan view the light transmissive parts 117a alternately with the light absorptive parts 117b.

### Embodiment 14

FIG. 22 is a schematic cross-sectional view showing an example of an optical film according to Embodiment 14. An optical film 110F according to Embodiment 14 is similar to that described for the display device 1-H according to Embodiment 8, and detailed description thereof is thus omitted. As shown in FIG. 22, the optical film 110F includes the semi-transparent component 111, the louver film 117, and a linear polarizer in the stated order. The linear polarizer may be the first linear polarizer 112 described above.

Use of the optical film 110F including the semi-transparent component 111, the louver film 117, and the first linear polarizer 112 in the stated order enables provision of both bright transmissive display and more vivid reflective display when a display panel is placed to face the first linear polarizer side of the optical film.

The linear polarizer may be one similar to the first linear polarizer mentioned as an example in Embodiment 1, and may be a linear polarizer including a polarizing film including dichroic molecules or a coating-type polarizing layer including dichroic molecules, for example.

The display devices and the optical films according to the embodiments, for example, may be used as an instrument panel of a vehicle to display instruments such as a speedometer, or may be used as a control panel of a home electrical appliance.

### REFERENCE SIGNS LIST

1-A, 1-B, 1-C, 1-D, 1-E, 1-F, 1-G, 1-H, 1001, 1002: display device
10: first substrate (TFT substrate)
20: second substrate (CF substrate)
21: supporting substrate
22: color filter layer
23: black matrix
30: liquid crystal layer
31: light emitting layer
40: sealant
51: second linear polarizer
52: third linear polarizer
53: second λ/4 waveplate
100: display panel
110A, 110B, 110C, 110D, 110E, 110F, 1110A, 1110B: optical film
111: semi-transparent component
112: first linear polarizer
112a: polarizing film including dichroic molecules
112b: protective film
113: transparent component
114: first λ/4 waveplate
115: antireflective layer
116: transparent film
117: louver film
117a: light transmissive part
117b: light absorptive part
200: backlight
300: enclosure
301: double-sided tape
302: light blocking component
400: smoke layer

What is claimed is:

1. A display device comprising:
an optical film; and
a display panel placed closer to a back surface side than the optical film is,
the optical film including a colored semi-transparent component and a first linear polarizer or louver film being placed closer to the back surface side than the colored semi-transparent component is and being integrated with the colored semi-transparent component, the louver film including a light absorptive part and a light transmissive part arranged in a pattern,
the semi-transparent component being configured to transmit part of light incident from the back surface side and reflect part of light incident from a viewer side opposite to the back surface side.

2. The display device according to claim 1,
wherein the display panel includes a second linear polarizer placed closer to the viewer side, and
a transmission axis of the first linear polarizer is parallel to a transmission axis of the second linear polarizer.

3. The display device according to claim 1,
wherein the first linear polarizer is an absorptive linear polarizer.

4. The display device according to claim 1,
wherein the light absorptive part and the light transmissive part of the louver film are alternately arranged in a plan view.

5. The display device according to claim 1,
wherein a transmittance of the semi-transparent component for light incident from the back surface side is 50% or higher.

6. The display device according to claim 1,
wherein the semi-transparent component includes a pigment that reflects light.

7. The display device according to claim 1,
wherein the optical film further includes a first λ/4 waveplate placed closer to the back surface side than the first linear polarizer is.

8. The display device according to claim 7,
wherein a transmission axis of the first linear polarizer and a slow axis of the first λ/4 waveplate form an angle of substantially 45°.

9. The display device according to claim 7,
wherein the display panel includes a second λ/4 waveplate and a second linear polarizer sequentially from the viewer side, and
a transmission axis of the second linear polarizer and a slow axis of the second λ/4 waveplate form an angle of substantially 45°, and a slow axis of the first λ/4 waveplate and the slow axis of the second λ/4 waveplate are orthogonal to each other.

10. The display device according to claim 1,
wherein the first linear polarizer is a coating-type polarizing layer including dichroic molecules, and
the coating-type polarizing layer including dichroic molecules is formed on the semi-transparent component.

11. The display device according to claim 1,
wherein the first linear polarizer is a linear polarizer that includes a polarizing film including dichroic molecules and a pair of protective films between which the polarizing film including dichroic molecules is held.

12. The display device according to claim 11,
wherein the optical film further includes a transparent film on a surface opposite to the surface on which the first linear polarizer is placed, and
a difference in coefficient of linear expansion between the transparent film and one of the protective films is 30×10⁻⁶/K or Less.

13. The display device according to claim 1,
wherein the optical film includes the semi-transparent component, the louver film, and a linear polarizer in the stated order.

14. The display device according to claim 1,
wherein the optical film further includes an antireflective layer placed closer to the back surface side than the first linear polarizer or the louver film is.

15. The display device according to claim 1,
wherein the display panel in a plan view includes a display region and a frame region surrounding the display region, and
the display panel in a plan view includes a light blocking component in a region overlapping the frame region.

16. An optical film comprising:
a colored semi-transparent component and a first linear polarizer or louver film being placed closer to a back surface side than the colored semi-transparent component is and being integrated with the colored semi-transparent component, the louver film including a light absorptive part and a light transmissive part arranged in a pattern,
the semi-transparent component being configured to transmit part of light incident from the back surface side and reflect part of light incident from a viewer side opposite to the back surface side.
